(19) United States
(12) Patent Application Publication
(10) Pub. No.: US 2024/0138028 A1
(43) Pub. Date: Apr. 25, 2024

(54) REINFORCED HEATER FOR AEROSOL-GENERATING DEVICE

(71) Applicant: Philip Morris Products S.A., Neuchatel (CH)

(72) Inventors: Silvia CAPO, Neuchatel (CH); Ivan PRESTIA, Calderara di Reno (IT)

(73) Assignee: Philip Morris Products S.A., Neuchatel (CH)

(21) Appl. No.: 18/547,357

(22) PCT Filed: Feb. 24, 2022
(86) PCT No.: PCT/EP2022/054656

§ 371 Date: Aug. 21, 2023

(30) Foreign Application Priority Data
Mar. 1, 2021 (EP) 21160057.2

(51) Int. Cl. H05B 3/18; A24F 40/46; A24F 40/70

(52) U.S. Cl. CPC H05B 3/18; A24F 40/46; A24F 40/70; H05B 2203/005; H05B 2203/017

(57) ABSTRACT

A heating element for an aerosol-generating device is provided, the heating element including: a first electrically resistive heating filament; and a support substrate on which the first electrically resistive heating filament is provided, the support substrate including a first carbon-fibre support layer comprising a carbon-fibre material. A method for forming a heating element for an aerosol-generating device is also provided. An aerosol-generating device including the heating element and a power source is also provided.

The present disclosure relates to a heating element for an aerosol-generating device, the aerosol-generating device being one for use with an aerosol generating article. In particular, the present invention relates to a heating element for an aerosol-generating device, the heating element comprising a first electrically resistive heating filament and a support substrate on which the first electrically resistive heating filament is provided.

The present disclosure also relates to a method for forming a heating element for an aerosol-generating device, and to an aerosol-generating device comprising a heating element.

Aerosol generating articles in which an aerosol-forming substrate, such as a tobacco containing substrate, is heated rather than combusted are known in the art. Typically, in such aerosol generating articles an aerosol is generated by the transfer of heat from a heat source to an aerosol-forming substrate.

Electrically operated aerosol-generating devices, for example handheld aerosol-generating devices, may be used with such aerosol generating articles. Such electrically operated aerosol-generating devices may comprise a heating element configured to heat an aerosol-forming substrate to temperatures of several hundred degrees centigrade. This releases volatile compounds from the aerosol-forming substrate which are entrained in air drawn through the aerosol generating article. As the released compounds cool, they condense or nucleate to form an aerosol.

The heating may be accomplished by heating the aerosol-forming substrate using external heating, such as a tubular heater, or by inserting a heating element, such as a resistive heating element, to internally heat the aerosol-forming substrate. Internal heating elements exist which may take the form of a heater blade or a heater pin. Internal heating elements may comprise an electrically resistive filament on, or embedded in, a support substrate. The substrate may comprise zirconium. However, it has been found that internal heating elements of the prior art may readily become damaged or break when subjected to relatively small forces, such as those to which the heating element is exposed during normal use or cleaning of the aerosol-generating device. In particular, it has been found that internal heating elements of the prior art may be brittle

Accordingly, it would be desirable to provide a heating element for an aerosol-generating device which is more resilient and less prone to damage during use of the aerosol-generating device.

The present disclosure relates to a heating element for an aerosol-generating device. The heating element may comprise a first electrically resistive heating filament. The heating element may further comprise a support substrate on which the first electrically resistive heating filament is provided. The support substrate may comprise a first carbon-fibre support layer comprising a carbon-fibre material.

According to the present invention, there is provided a heating element for an aerosol-generating device. The heating element comprises a first electrically resistive heating filament. The heating element further comprises a support substrate on which the first electrically resistive heating filament is provided. The support substrate comprises a first carbon-fibre support layer comprising a carbon-fibre material.

It has been found that a heating element for an aerosol-generating device having a support substrate comprising a first carbon-fibre support layer comprising a carbon-fibre material is advantageously more resilient and less prone to damage during use of the aerosol-generating device. In particular, it has been found that a heating element having a support substrate comprising a first carbon-fibre support layer comprising a carbon-fibre material has a significantly higher resistance to bending forces. This is particularly relevant where the heating element is an elongate heating element.

As used herein with reference to the present invention, the term “carbon-fibre material” refers to a material comprising fibres of carbon having a diameter of between about 1 micrometre and about 20 micrometres. The fibres of carbon, or carbon-fibres, may be crystalline. Carbon-fibres have been found to have particularly high stiffness and high tensile strength. These properties in particular improve the resilience of a heating element comprising a support substrate comprising a carbon-fibre material. Furthermore, carbon-fibres have been found to exhibit resistance to high temperature degradation and low thermal expansion. This is advantageous for the carbon-fibre material's application in a heating element which may be heated to several hundred degrees Celsius in use.

The heating element may be for heating an aerosol-forming substrate, for example an aerosol-forming substrate of an aerosol generating article for use with the aerosol-generating device.

The heating element may be any heating element. For example, the heating element may be an external heating element or an internal heating element. Preferably, the heating element is an internal heating element configured to be inserted into an aerosol-forming substrate of an aerosol generating article in order to heat the aerosol-forming substrate. The heating element may be a pin heater. The heating element may be substantially planar and elongate. Where this is the case, the heating element may be relatively thin. The provision of a thin heating element may allow the blade to easily penetrate the aerosol-forming substrate. The heating element may be a blade heater.

The heating element may have a tapered, pointed or sharpened end to facilitate insertion of the heating element into the aerosol-forming substrate of the aerosol generating article. The longitudinal distance between the start of the taper and the end of the taper may be between about 1 millimetre and about 7 millimetres, or between about 3 millimetres and about 5 millimetres.

As used herein with reference to the present invention, the term “aerosol-generating device” relates to a device that may interact with an aerosol-forming substrate to generate an aerosol.

As used herein with reference to the present invention, the term “aerosol-forming substrate” relates to a substrate capable of releasing volatile compounds that may form an aerosol. Such volatile compounds may be released by heating the aerosol-forming substrate. The aerosol-forming substrate may be part of an aerosol generating article.

As used herein with reference to the present invention, the term “aerosol generating system” refers to a combination of an aerosol-generating device and one or more aerosol generating articles for use with the device. An aerosol-generating system may include additional components, such as a charging unit for recharging an on-board electric power supply in an electrically operated or electric aerosol-generating device.

The heating element may have any length. As used herein, the “length” refers to the largest dimension of the heating element. The heating element may have a length of between about 3 millimetres and about 30 millimetres, between about 7 millimetres and about 25 millimetres, or between about 12 millimetres and about 21 millimetres.

The heating element may have any width. As used herein, the “width” refers to the second largest dimension of the heating element which is orthogonal to the length. The heating element may have a width of between about 2 millimetres and about 15 millimetres, between about 3 millimetres and about 11 millimetres, or between about 4 millimetres and about 7 millimetres.

The heating element may have any total thickness. As used herein, the “thickness” refers to the dimension of the heating element which is orthogonal to the length and the width. The thickness of the heating element may be less than the length of the heating element and the width of the heating element. The heating element may have a total thickness of between about 0.1 millimetres and about 2 millimetres. For example, the heating element may have a total thickness of between about 0.3 millimetres and about 1.5 millimetres, or between about 0.4 millimetres and about 0.9 millimetres. The heating element may have a total thickness of between about 0.4 millimetres and about 1.7 millimetres, or between about 0.5 millimetres and about 1.1 millimetres. The heating element may have a total thickness of between about 0.5 millimetres and about 1.9 millimetres, or between about 0.6 millimetres and about 1.3 millimetres.

The heating element may further comprise a second electrically resistive heating filament.

The provision of a second electrically resistive heating filament may advantageously provide more efficient or more even heating of the aerosol-forming substrate.

The second electrically resistive heating filament may comprise an electrically resistive material. The second electrically resistive heating filament may comprise the same material as the first electrically resistive heating filament. The second electrically resistive heating filament may have substantially the same geometry as the first electrically resistive heating filament. The second electrically resistive heating filament may be configured to reach the same temperature as the first electrically resistive heating filament in use.

As set out above, the heating element may be substantially planar and elongate. Where this is the case, the heating element may have a first surface and an opposed second surface.

The first carbon-fibre support layer may comprise a first surface and an opposed second surface, the first electrically resistive heating filament being provided on the first surface of the first carbon-fibre support layer, and the second electrically resistive heating filament being provided on the second surface of the first carbon-fibre support layer.

In other words, the first and second electrically resistive heating filaments are disposed on opposite surfaces of the carbon-fibre support layer. This may advantageously prevent the two electrically resistive heating filaments from electrically interfering with each other. This may also help to provide even heating to the aerosol-forming substrate.

The first electrically resistive heating filament may be in direct contact with the first carbon-fibre support layer.

The first electrically resistive heating filament may be provided on the first carbon-fibre support layer. The first electrically resistive heating filament may be embedded within the first carbon-fibre support layer.

The support substrate may comprise at least one further layer. The further layer may be provided to further improve the resilience of the heating element making it less prone to damage during use of the aerosol-generating device.

The support substrate may further comprise a first ceramic support layer comprising a ceramic material. The first ceramic support layer may be in contact with the first carbon-fibre support layer.

The provision of a first ceramic support layer has been found to advantageously improve the resilience of the heating element making it less prone to damage during use of the aerosol-generating device compared to providing the carbon-fibre support layer alone. In particular, the provision of a first ceramic support layer may advantageously exhibit high resistance to bending forces longitudinally applied and predominantly transversal to its wider surfaces.

As used herein with reference to the present invention, the term “ceramic material” generally refers to an inorganic, non-metallic, often crystalline oxide, nitride or carbide material. The term “ceramic material” also refers to silicon, glass and certain carbon allotropes which will be familiar to the skilled person. Such ceramic materials typically exhibit resistance to high temperature degradation and low thermal expansion. Accordingly, the provision of a first ceramic support layer may advantageously resist any degradation when the heating element is used.

The first ceramic support layer may be in contact with the first carbon-fibre support layer. The first ceramic support layer may be aligned with the first carbon-fibre support layer. The first ceramic support layer may overlay the first carbon-fibre support layer. The first ceramic support layer may have substantially the same shape as the first carbon-fibre support layer. The first ceramic support layer may be a substantially planar and elongate in shape.

The first ceramic support layer may be attached to the first carbon-fibre support layer. The first ceramic support layer may be attached to the first carbon-fibre support layer by any means. For example, the first ceramic support layer may be applied as a layer of liquid ceramic on the surface of the first carbon-fibre support layer. Where this is the case, the first ceramic support layer may be applied to the surface of the first carbon-fibre support layer by at least one of, spraying, dip coating, chemical deposition, and electromagnetic deposition. The application of the first carbon-fibre support layer using one of these techniques may advantageously lead to improved mechanical properties of the first carbon-fibre support layer such as improved elasticity.

The first electrically resistive heating filament may be provided on the first ceramic support layer.

The provision of the first electrically resistive heating filament on the first ceramic support layer rather than on the first carbon-fibre support layer may be advantageous since techniques which are suitable for applying a first electrically resistive heating filament to a ceramic material may not be suitable for applying a first electrically resistive heating filament to a carbon-fibre material. For example, certain deposition or adhesive techniques which may be readily used to apply a first electrically resistive heating filament to a ceramic material may not be suitable to apply a first electrically resistive heating filament to a carbon-fibre material.

The first ceramic support layer may comprise a first surface and an opposed second surface, the first electrically resistive heating filament being provided on the first surface of the first ceramic support layer, and the first carbon-fibre support layer being provided on the second surface of the first ceramic support layer.

The provision of the first electrically resistive heating filament on a first surface of the first ceramic support layer and the first carbon-fibre support layer being provided on the second surface of the first ceramic support layer may allow the first electrically resistive heating filament to be disposed on, or very near to, the surface of the heating element. This may advantageously improve the heating efficiency of the hearing element when in use.

As set out above, the first ceramic support layer may be substantially planar and elongate in shape. Where this is the case, the first surface of the ceramic support layer may directly oppose the second surface of the first ceramic support layer such that the first electrically resistive heating filament is provided on the opposite surface of the first ceramic support layer to the first carbon-fibre support layer.

The support substrate may further comprise a second ceramic support layer comprising a ceramic material. The second ceramic support layer may be in contact with the first carbon-fibre support layer.

The second ceramic support layer may share one or more of the properties set out above in relation to the first ceramic support layer. The second ceramic support layer may be substantially the same size as the first ceramic support layer. The second ceramic support layer may be substantially the same shape as the first ceramic support layer. In some preferred embodiments, the first ceramic support layer, the second ceramic support layer, and the first carbon-fibre support layer are the same size and shape and are aligned and are orientated in the same direction.

The first carbon-fibre support layer may comprise a first surface and an opposed second surface, the first ceramic support layer being provided on the first surface of the first carbon-fibre support layer, and the second ceramic support layer being provided on the second surface of the first carbon-fibre support layer, the first electrically resistive heating filament being provided on the first ceramic support layer.

In other words, the first carbon-fibre support layer may be sandwiched between the first ceramic support layer and the second ceramic support layer.

This arrangement may advantageously further strengthen and improve the resilience of the heating element making it less prone to damage during use of the aerosol-generating device. Furthermore, depending on the nature of the carbon-fibre material, it may be desirable to prevent the first carbon-fibre support layer from coming into direct contact with the aerosol-forming substrate in use. Accordingly, the provision of a ceramic support layer on each of the two surfaces of the first carbon-fibre support layer may advantageously prevent the carbon-fibre material from coming into direct contact with the aerosol-forming substrate in use.

The first electrically resistive heating filament may be provided on the first ceramic support layer. The first electrically resistive heating filament may be provided on a first surface of the first ceramic support layer and the first carbon-fibre support layer may be provided on the second surface of the first ceramic support layer. In this way, the first electrically resistive heating filament may be provided on, or close to, the outermost surface of the heating element. This may advantageously provide more efficient heating of the aerosol-forming substrate in use.

The heating element may further comprise a second electrically resistive heating filament provided on the second ceramic support layer.

As set out above, the provision of a second electrically resistive heating filament may advantageously provide more efficient or more even heating of the aerosol-forming substrate.

The second electrically resistive heating filament may comprise an electrically resistive material. The electrically resistive material may be one or more of the materials set out above in relation to first electrically resistive heating filament. The second electrically resistive heating filament may comprise the same material as the first electrically resistive heating filament. The second electrically resistive heating filament may have substantially the same geometry as the first electrically resistive heating filament. The second electrically resistive heating filament may be configured to reach the same temperature as the first electrically resistive heating filament in use.

Providing the second electrically resistive heating filament on the second ceramic support layer may advantageously prevent the two electrically resistive heating filaments from electrically interfering with each other since the first electrically resistive heating filament is provided on the first ceramic support layer. This may also help to provide even heating to the aerosol-forming substrate.

The heating element may further comprise a protective coating around at least a portion of the first electrically resistive heating filament and the support substrate.

The provision of a protective coating may advantageously further improve the resilience of the heating element. During the manufacture of heating elements, the support substrate may be cut from larger portions of material, for example from carbon-fibre material and ceramic material. This process may damage the exposed cut edges of the support substrate leading to residual stresses and micro-cracks. Thermal cycles of the heating element and contamination from the aerosol-forming substrate during use has been found to promote the propagation of micro-cracks which can lead to the failure of the heating element after several uses. Furthermore, where the support substrate comprises a plurality of layers, delamination between the layers has been observed during prolonged use of the heating element. The provision of a protective coating may advantageously prevent liquid or solid contaminates from reaching the support substrate and may also reduce micro-crack propagation and delamination in the support substrate.

Where the support substrate comprises further layers, for example a first or second ceramic support layer, the protective coating may also be provided around at least a portion of these components.

The protective coating may be provided around substantially the entire outer surface of the first electrically resistive heating filament and the support substrate. The protective coating may be provided around the portion of the first electrically resistive heating filament and the support substrate which is positioned to be inserted into the aerosol-forming substrate of the aerosol generating article in use. In this way, when the heating element is used to heat an aerosol-forming substrate of an aerosol generating article, only the protective coating of the heating element is in direct contact with the aerosol-forming substrate.

This may advantageously prevent liquid or solid contaminates from reaching the support substrate in use.

The protective coating may not be provided around the portion of the first electrically resistive heating filament and the support substrate which is not positioned to be inserted into the aerosol-forming substrate of the aerosol generating article in use. This may advantageously provide a portion of the support substrate which remains uncoated for attachment to the rest of the aerosol-generating device. This may also advantageously allow for the first electrically resistive heating filament, and where present the second electrically resistive heating filament, to be electrically connected to the rest of the aerosol-generating device.

The protective coating may have any thickness. The thickness of the protective coating may be substantially uniform across all parts of the first electrically resistive heating filament and support substrate where it is provided.

The protective coating may have a thickness of between about 4 micrometres and about 1 millimetre. For example, the protective coating may have a thickness of between about 4 micrometres and about 0.5 millimetres.

The protective coating may comprise any material. The protective coating may comprise a material having a resistance to high temperature deformation and low thermal expansion. This may advantageously allow the protective coating to be used in the high temperature environment of the heater element.

The protective coating may comprise a ceramic material. The protective coating may comprise at least one of glass and quartz.

The carbon-fibre material of the first carbon-fibre support layer, may comprise any carbon-fibre material.

The carbon-fibres of the first carbon-fibre material may be woven. The woven carbon-fibre material may have any weave. For example, the woven carbon-fibre material may comprise at least one of a plain weave, a twill weave, or a satin weave. The twill weave may be a 2×2 weave.

The carbon-fibres of the first carbon-fibre material may be non-woven. For example, the non-woven fibres may comprise chopped or continuous strand mats.

The carbon-fibres of the first carbon-fibre material may be unidirectional. In other words, the carbon-fibres of the first carbon-fibre material may be substantially parallel to one another. The provision of unidirectional carbon-fibres may advantageously allow tight packing of the carbon-fibres which increases the density of the first carbon-fibre material and may advantageously further increase the strength of the first carbon-fibre material for a given volume of carbon-fibre material. The provision of a first carbon-fibre material having unidirectional carbon-fibres may be particularly advantageous for contexts where strength in a particular direction is more important than homogeneous strength. In the present invention, there is a need to provide improved bending resistance to longitudinally applied forces when applied substantially transverse to the planar surfaces of the heating element.

The substantially parallel carbon-fibres of the first carbon-fibre material may be substantially aligned to the longitudinal axis of the heating element. This may advantageously further improve the stiffness and resistance to bending of the heating element, particularly in response to forces applied substantially transverse to the planar surfaces of the heating element.

Furthermore, the provision of a first carbon-fibre material comprising unidirectional carbon-fibres may be advantageous since they may be more economical and easier to process compared to woven carbon-fibres.

The carbon-fibres of the first carbon-fibre material may be multidirectional. For example, the first carbon-fibre material may comprise at least one of biaxially orientated carbon-fibres, triaxially orientated carbon-fibres, or quasi-isotropic carbon-fibres.

The first carbon-fibre support layer may comprise a non-woven, unidirectional carbon-fibre material.

The first carbon-fibre support layer may comprise a plurality of different carbon-fibre materials. For example, the first carbon-fibre support layer may comprise a unidirectional carbon-fibre material and a woven carbon-fibre material. The first carbon-fibre material may comprise a first unidirectional carbon-fibre material orientated in a first direction and a second unidirectional carbon-fibre material orientated in a second direction. The first direction may be substantially orthogonal to the second direction. In this way, the first carbon-fibre support layer may be able to advantageously provide strength in two perpendicular directions. The first direction may be aligned with the axis of the heating element.

The carbon-fibre material may comprise carbon-fibres having any tow size. For example, the carbon-fibre material may comprise carbon-fibres having a tow size of between about 1000 filaments per tow and about 12000 filaments per tow, between about 3000 filaments per tow and about 6000 filaments per tow. The carbon-fibre material may comprise carbon-fibres having a tow size of about 48000 filaments per tow or greater.

The carbon-fibre material may be a composite material comprising a matrix reinforced with carbon-fibres. The matrix may comprise at least one of a polymeric material. The polymeric material may be a thermoplastic or a thermosetting plastic. The polymeric material may comprise at least one of polyethylene, polyethylene terephthalate, polybutylene terephthalate, polycarbonate, acrylonitrile butadiene styrene, polyamide, polypropylene, epoxy resin, polyester, vinyl ester, phenolic resin, cyanate ester, bismaleimide, and nylon. The matrix may comprise at least one of a metallic material, a ceramic material, and a carbon containing material.

The first carbon-fibre support layer may have any thickness. The first carbon-fibre support layer may have a thickness of at least about 0.05 millimetres. For example, the first carbon-fibre support layer may have a thickness of at least about 0.1 millimetres, at least about 0.3 millimetres, or at least 0.4 millimetres.

The first carbon-fibre support layer may have a thickness of no more than about 2 millimetres. For example, the first carbon-fibre support layer may have a thickness of no more than about 1.5 millimetres, no more than about 1 millimetre, or no more than about 0.9 millimetres.

The first carbon-fibre support layer may have a thickness of between about 0.05 millimetres and about 2 millimetres. For example, the first carbon-fibre support layer may have a thickness of between about 0.1 millimetres and about 1.5 millimetres, between about 0.3 millimetres and about 1.5 millimetres, between about 0.3 millimetres and about 1 millimetre, or between about 0.4 millimetres and about 0.9 millimetres.

It has been found that support substrates comprising a first carbon-fibre support layer having this thickness advantageously improves the resilience of the heating element making it less prone to damage during use of the aerosol-generating device.

All of the properties set out above in relation to the first carbon-fibre support layer are equally applicable to the second carbon-fibre support layer.

The first ceramic support layer may comprise any ceramic material. The first ceramic support layer may comprise at least one of steatite, alumina and zirconia. Advantageously, these materials are chemically stable and have relatively low coefficients of thermal expansion.

The first ceramic support layer may comprise silicon. Silicon is particularly advantageous for use in the first ceramic support layer since it is relatively straightforward to process and may be ground using common grinding equipment to form an ultra-thin layer. Additionally, ultra-thin layers of silicon have been found to be relatively flexible allowing for robust handling during high-speed manufacturing and desirable mechanical properties in the finished support substrate.

Furthermore, the surface of silicon may be suitable for metallic deposition using known techniques. This may allow for straightforward provision of the first electrically resistive heating filament where the first electrically resistive heating filament is provided on the first ceramic support layer.

The first ceramic support layer may have any thickness. The first ceramic support layer may have a thickness of at least about 0.05 millimetres. For example, first ceramic support layer may have a thickness of at least about 0.07 millimetres, at least about 0.09 millimetres, or at least 0.1 millimetres.

The first ceramic support layer may have a thickness of no more than about 1 millimetre. For example, the first ceramic support layer may have a thickness of no more than about 0.9 millimetres, no more than about 0.8 millimetre, or no more than about 0.7 millimetres.

The first ceramic support layer may have a thickness of between about 0.05 millimetres and about 1 millimetre. For example, the first ceramic support layer may have a thickness of between about 0.07 millimetres and about 0.9 millimetres, between about 0.09 millimetres and about 0.8 millimetres, or between about 0.1 millimetres and about 0.7 millimetres.

The first ceramic support layer may have a thickness of at least about 0.4 millimetres. For example, first ceramic support layer may have a thickness of at least about 0.5 millimetres, or at least 0.6 millimetres.

The first ceramic support layer may have a thickness of no more than about 1.5 millimetres. For example, the first ceramic support layer may have a thickness of no more than about 1.1 millimetres, or no more than about 0.9 millimetres.

The first ceramic support layer may have a thickness of between about 0.4 millimetres and about 1.5 millimetres. For example, the first ceramic support layer may have a thickness of between about 0.5 millimetres and about 1.5 millimetres, between about 0.5 millimetres and about 1.1 millimetres, or between about 0.6 millimetres and about 0.9 millimetres.

It has been found that support substrates comprising a first ceramic support layer having this thickness advantageously provides the desired balance between mechanical strength and processability.

The first electrically resistive heating filament may comprise any suitable material. The first electrically resistive heating filament may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium- titanium- zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys.

The first electrically resistive heating filament may comprise platinum.

The first electrically resistive heating filament may comprise a track deposited onto the surface of the support substrate. The first electrically resistive heating filament may have any shape. For example, the first electrically resistive heating filament may have a serpentine shape. This may advantageously provide more efficient or more even heating of the aerosol-forming substrate.

All of the properties set out above in relation to the first electrically resistive heating filament are equally applicable to the second electrically resistive heating filament. For example, the second electrically resistive heating filament may comprise an electrically resistive material. The electrically resistive material may be one or more of the materials set out above in relation to first electrically resistive heating filament.

The present disclosure may also relate to a method for forming a heating element for an aerosol-generating device. The method may comprise the step of providing a carbon-fibre material. The method may comprise a step of applying a conductive material to a first surface of the carbon-fibre material to form a first electrically resistive heating filament. The method may comprise a step of cutting a portion from the carbon-fibre material to form a heating element.

According to a second aspect of the present invention, there is provided a method for forming a heating element for an aerosol-generating device, the method comprising steps of, providing a carbon-fibre material, applying a conductive material to a first surface of the carbon-fibre material to form a first electrically resistive heating filament, and cutting a portion from the carbon-fibre material to form a heating element.

The process of forming the carbon-fibre material may comprise starting with a precursor polymer material. The precursor polymer material may comprise polyacrylonitrile (PAN). The precursor polymer material may be spun into fine fibres which may be washed and stretched to produce fibres of the polymer material. The fibres of polymer material may be heated to between 200 degrees Celsius and 370 degrees Celsius. The heating process adds oxygen molecules and rearranges the atomic bonding pattern to convert their linear pattern to a more thermally stable ladder bonding. The fibres of polymer material may be heated to between 1100 degrees Celsius and 2800 degrees Celsius in an oxygen free environment. This may expel non-carbon atoms from the material to form the carbon-fibres.

The carbon-fibres may be collected into bundles and wound into bobbins. The wound bundles may then be turned into a usable carbon-fibre material, such as a woven carbon-fibre material, using a loom.

The step of cutting a portion from the carbon-fibre material to form a heating element may comprise dicing. The step of cutting a portion of the carbon-fibre material to form a heating element may involve cutting a portion of the carbon-fibre material on which the first electrically resistive heating filament is provided.

The method may further comprise a step of applying a conductive material to a second surface of the carbon-fibre material to form a second electrically resistive heating filament.

The step of applying the a conductive material to a second surface of the carbon-fibre material to form a second electrically resistive heating filament may use the same technique used to apply a conductive material to a first surface of the carbon-fibre material.

The method may further comprise a step of applying a layer at least one of quartz and glass to the heating element to form a protective coating.

The step of applying a layer of at least one of quartz and glass to the heating element may comprise dip coating or 3D deposition.

The step of applying a conductive material to a first surface of the carbon-fibre material may involve depositing a conductive material to a first surface of the carbon-fibre material.

For example, this step may apply depositing an amount of platinum to the surface of the carbon-fibre material. The step of depositing the conductive material may involve any suitable deposition technique including, but not limited to chemical vapour deposition (CVD), physical vapour deposition (PVD), sputtering, atomic laser deposition (ALD).

The method may further comprise a step of providing a ceramic material and applying the ceramic material to the carbon-fibre material. The method may further provide a step of applying a conductive material to a first surface of the ceramic material to form a first electrically resistive heating filament. The step of applying a conductive material to a first surface of the ceramic material may be in place of the step of applying a conductive material to a first surface of the carbon-fibre material.

The ceramic material may be silicon.

The step of applying the a conductive material to the first surface of the ceramic material to form a first electrically resistive heating filament may use the same technique used to apply a conductive material to a first surface of the carbon-fibre material set out above.

The method may further comprise a step of cutting a portion of the ceramic material and carbon-fibre material to form a heating assembly.

The method may further comprise a step of providing a further ceramic material and applying the further ceramic material to the carbon-fibre material. The step of applying the further ceramic material to the carbon-fibre material may act to sandwich the carbon-fibre material between two layers of ceramic material. The first ceramic material may be the same ceramic material as the second ceramic material.

Where the method comprises a step of providing a further ceramic material, the method may further comprise a step of applying a conductive material to a surface of the further ceramic material to form a second electrically resistive heating filament.

The step of applying the conductive material to the surface of the further ceramic material to form a second electrically resistive heating filament may use the same technique used to apply a conductive material to a first surface of the carbon-fibre material set out above.

According to a third aspect of the present invention, there is provided an aerosol-generating device comprising a heating element according to the first aspect of the invention, and a power source for providing electrical power to the first electrically resistive heating filament.

The aerosol-generating device may further comprise a housing and a control element configured to control the supply of power from the power source to the heating element. The housing may define a cavity surrounding or in vicinity of the heating element. The cavity may be configured to receive an aerosol generating article. The cavity may form or comprise the heating chamber of the aerosol-generating device.

The aerosol-generating device may be a portable or handheld aerosol-generating device that is comfortable for a user to hold between the fingers of a single hand. The aerosol-generating device may be substantially cylindrical in shape. The aerosol-generating device may have a length of between about 70 millimetres and about 120 millimetres.

The heating element may be an internal heating element that is arranged within the heating chamber of the aerosol-generating device. The heating element may be arranged centrally in and aligned along the longitudinal axis of the heating chamber.

The aerosol generating article to be received in the aerosol-generating device may be substantially cylindrical in shape. The aerosol generating article may be substantially elongate. The aerosol generating article may have a length and a circumference substantially perpendicular to the length. The aerosol-forming substrate may be substantially cylindrical in shape. The aerosol-forming substrate may be substantially elongate. The aerosol-forming substrate may also have a length and a circumference substantially perpendicular to the length. The aerosol generating article may have a total length of about 45 millimetres. The aerosol generating article may have an external diameter of about 7.2 millimetres. Further, the aerosol-forming substrate may have a length of about 10 millimetres. Alternatively, the aerosol-forming substrate may have a length of about 12 millimetres. Further, the diameter of the aerosol-forming substrate may be between about 5 millimetres and about 12 millimetres. The aerosol generating article may comprise an outer paper wrapper. The aerosol generating article may comprise a filter plug. Further, the aerosol generating article may comprise a separation between the aerosol-forming substrate and the filter plug. The separation may be about 18 millimetres, but may be in the range of about 5 millimetres to about 25 millimetres.

The aerosol-forming substrate is a substrate capable of releasing volatile compounds that can form an aerosol. The volatile compounds may be released by heating the aerosol-forming substrate. The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

The aerosol-generating device may comprise a control element, a power source and contacts. The contacts electrically contact the first electrically resistive heating filament, and where present the second electrically resistive heating filament, of the heating element.

The power source may be any suitable power source, for example a DC voltage source such as a battery. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery.

The control element may be a simple switch. Alternatively the control element may be electric circuitry and may comprise one or more microprocessors or microcontrollers.

In another aspect of the disclosure, there is provided an aerosol-generating system comprising an aerosol-generating device according to the description above and one or more aerosol generating articles configured to be received in the cavity of the aerosol-generating device.

The invention is defined in the claims. However, below there is provided a non-exhaustive list of non-limiting examples. Any one or more of the features of these examples may be combined with any one or more features of another example, embodiment, or aspect described herein.

### EXAMPLE 1

A heating element for an aerosol-generating device, the heating element comprising: a first electrically resistive heating filament, and a support substrate on which the first electrically resistive heating filament is provided, the support substrate comprising a first carbon-fibre support layer comprising a carbon-fibre material.

### EXAMPLE 2

A heating element according to Example 1, further comprising a second electrically resistive heating filament.

### EXAMPLE 3

A heating element according to Example 2, wherein the first carbon-fibre support layer comprises a first surface and an opposed second surface, the first electrically resistive heating filament being provided on the first surface of the first carbon-fibre support layer, and the second electrically resistive heating filament being provided on the second surface of the first carbon-fibre support layer.

### EXAMPLE 4

### A heating element according to any preceding Example, wherein the first electrically resistive heating filament is in direct contact with the first carbon-fibre support layer.

### EXAMPLE 5

A heating element according to Example 1, wherein the support substrate further comprises a first ceramic support layer comprising a ceramic material, the first ceramic support layer being in contact with the first carbon-fibre support layer.

### EXAMPLE 6

A heating element according to Example 5, wherein the first electrically resistive heating filament is provided on the first ceramic support layer.

### EXAMPLE 7

A heating element according to Example 6, wherein the first ceramic support layer comprises a first surface and an opposed second surface, the first electrically resistive heating filament being provided on the first surface of the first ceramic support layer, and the first carbon-fibre support layer being provided on the second surface of the first ceramic support layer.

### EXAMPLE 8

A heating element according to any one of Examples 5 to 7, wherein the support substrate further comprises a second ceramic support layer comprising a ceramic material, the second ceramic support layer being in contact with the first carbon-fibre support layer.

### EXAMPLE 9

A heating element according to Example 8, wherein the first carbon-fibre support layer comprises a first surface and an opposed second surface, the first ceramic support layer being provided on the first surface of the first carbon-fibre support layer, and the second ceramic support layer being provided on the second surface of the first carbon-fibre support layer, the first electrically resistive heating filament being provided on the first ceramic support layer.

### EXAMPLE 10

A heating element according to Example 8 or Example 9, further comprising a second electrically resistive heating filament provided on the second ceramic support layer.

### EXAMPLE 11

A heating element according to any one of Examples 5 to 10, wherein the first ceramic support layer comprises silicon.

### EXAMPLE 12

A heating element according to any one of Examples 5 to 11, wherein the first ceramic support layer has a thickness of between 0.1 millimetres and 0.7 millimetres.

### EXAMPLE 13

A heating element according to any preceding Example, further comprising a protective coating around at least a portion of the first electrically resistive heating filament and the support substrate.

### EXAMPLE 14

A heating element according to Example 13, wherein the protective coating comprises at least one of glass and quartz.

### EXAMPLE 15

A heating element according to any preceding Example, wherein the first carbon-fibre support layer comprises a non-woven, unidirectional carbon-fibre material.

### EXAMPLE 16

A heating element according to any preceding Example, wherein the first carbon-fibre support layer has a thickness of between 0.3 millimetres and 1.5 millimetres.

### EXAMPLE 17

A heating element according to any preceding Example, wherein the first electrically resistive heating filament comprises platinum.

### EXAMPLE 18

A method for forming a heating element for an aerosol-generating device, the method comprising steps of, providing a carbon-fibre material, applying a conductive material to a first surface of the carbon-fibre material to form a first electrically resistive heating filament, and cutting a portion from the carbon-fibre material to form a heating element.

### EXAMPLE 19

A method for forming a heating element according to Example 18, further comprising a step of applying a conductive material to a second surface of the carbon-fibre material to form a second electrically resistive heating filament.

### EXAMPLE 20

A method for forming a heating element according to Example 18 or Example 19, further comprising a step of applying a layer of at least one of quartz and glass to the heating element to form a protective coating.

### EXAMPLE 21

A method for forming a heating element according to Example 20, wherein the step of applying a layer of at least one of quartz and glass to the heating element comprises dip coating or 3D deposition.

### EXAMPLE 22

A method for forming a heating element according to any one of Examples 18 to 21, wherein the step of applying a conductive material to a first surface of the carbon-fibre material involves depositing a conductive material to a first surface of the carbon-fibre material.

### EXAMPLE 23

An aerosol-generating device comprising: a heating element according to any one of Examples 1 to 17, and a power source for providing electrical power to the first electrically resistive heating filament.

Examples will now be further described with reference to the figures in which:

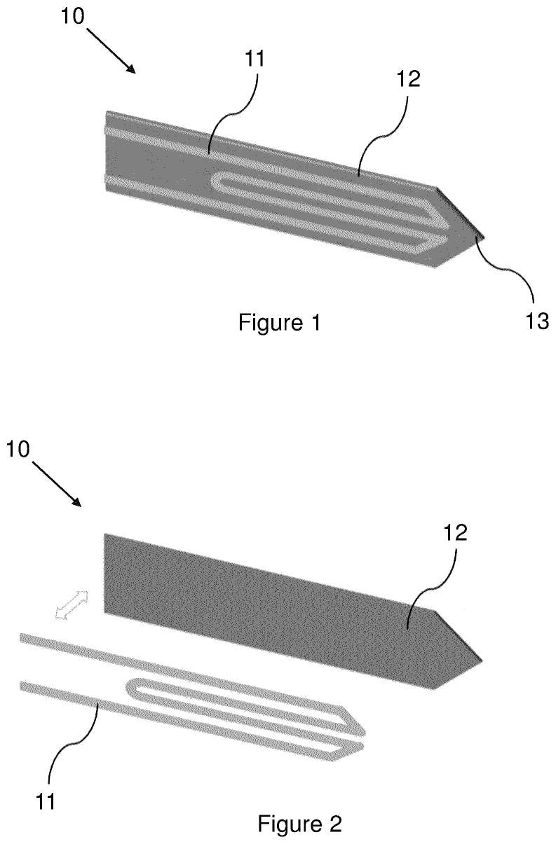

FIG. 1 shows a heating element according to a first embodiment of the invention.

FIG. 2 shows an exploded view of a heating element according to a first embodiment of the invention.

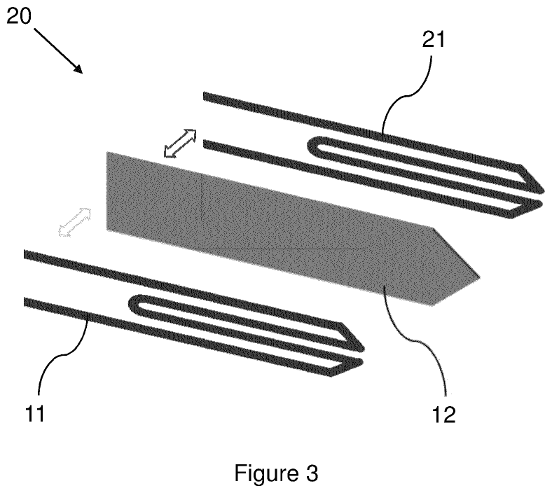

FIG. 3 shows an exploded view of a heating element according to a second embodiment of the invention.

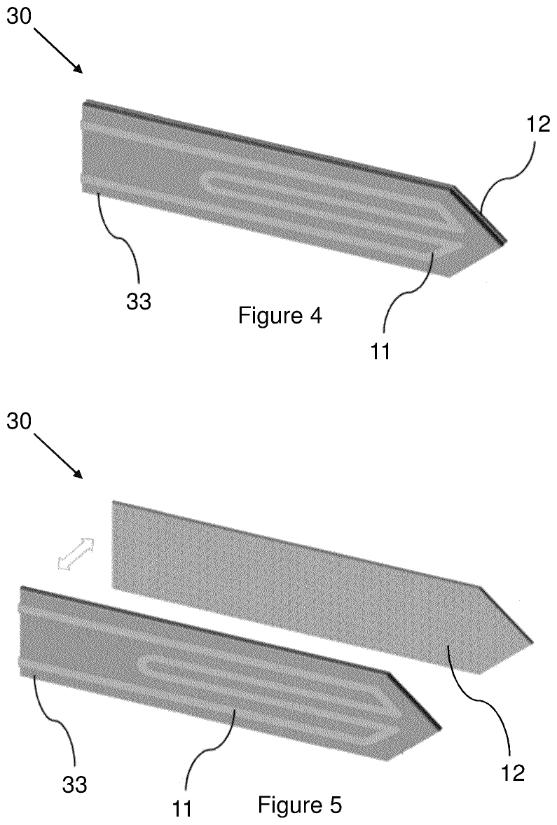

FIG. 4 shows a heating element according to a third embodiment of the invention.

FIG. 5 shows an exploded view of a heating element according to a third embodiment of the invention.

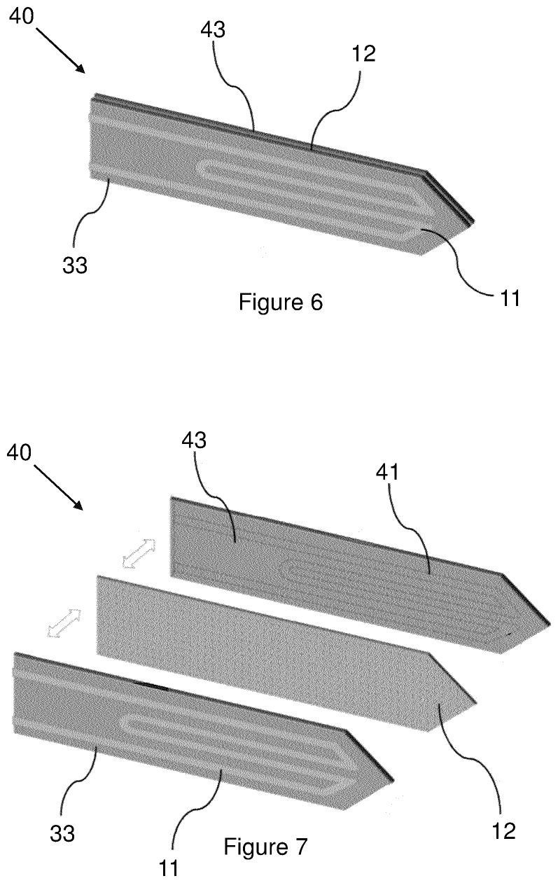

FIG. 6 shows a heating element according to a fourth embodiment of the invention.

FIG. 7 shows an exploded view of a heating element according to a fourth embodiment of the invention.

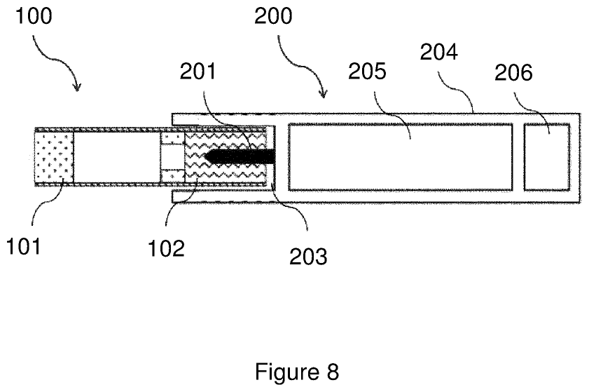

FIG. 8 shows a schematic view of an aerosol-generating device according to the present invention and an aerosol-generating article.

FIG. 1 and FIG. 2 show a heating element 10 for an aerosol-generating device. The heating element 10 comprises a first electrically resistive heating filament 11 provided on a support substrate. The support substrate is formed from a first carbon-fibre support layer 12. The first carbon-fibre support layer 12 is formed from a carbon-fibre material. The carbon-fibre material comprises non-woven, unidirectional carbon-fibres. The longitudinal axis of the unidirectional carbon-fibres in the carbon-fibre material is aligned with the longitudinal axis of the heating assembly. The carbon-fibres in the carbon-fibre material have a tow size of 6000 filaments per tow. The carbon-fibre material is a composite material comprising a matrix reinforced with carbon-fibres. The matrix comprises polyimide.

The first carbon-fibre support layer 12 has a thickness of about 0.6 millimetres.

The first electrically resistive heating filament 11 is a layer of platinum deposited on the surface of the first carbon-fibre support layer 12. The first electrically resistive heating filament 11 is serpentine in shape and has two ends which extend to a first end of the support substrate to allow for electrical connection to the rest of the aerosol-generating device.

The heating element 20 shown in FIG. 3 shares many features with the heating element 10 shown in FIG. 1 and FIG. 2. The differences are set out below. FIG. 3 shows an exploded view of the heating element 20.

The support substrate is formed from a first carbon-fibre support layer 12. The first carbon-fibre support layer 12 comprises a first surface and an opposed second surface. The first electrically resistive heating filament 11 is provided on the first surface of the carbon-fibre support layer 12. A second electrically resistive heating filament 21 is provided on the second surface of the carbon-fibre support layer 12. The second electrically resistive heating filament 21 is substantially the same shape and has the same properties as the first electrically resistive heating filament 11.

The heating element 30 shown in FIG. 4 and FIG. 5 shares many features with the heating element 10 shown in FIG. 1 and FIG. 2. The differences are set out below.

The support substrate further comprises a first ceramic support layer 33. The first ceramic support layer 33 comprises silicon. The first ceramic support layer 33 has a thickness of about 0.4 millimetres. The first ceramic support layer 33 is the same shape as, and is aligned with the first carbon-fibre support layer 12.

Unlike in the embodiments shown in FIGS. 1 to 3, the first electrically resistive heating filament 11 is provided on a surface of the first ceramic support layer 33 rather than on a surface of the first carbon-fibre support layer 12. The first electrically resistive heating filament 11 is provided on a first surface of the first ceramic support layer 33 and the first carbon-fibre support layer 12 is provided on a second opposing surface of the first ceramic support layer 33.

The heating element 40 shown in FIG. 6 and FIG. 7 shares many features with the heating element 30 shown in FIG. 4 and FIG. 5. The differences are set out below.

The heating element 40 further comprises a second ceramic support layer 43. The second ceramic support layer 43 is formed from the same material, and has the same dimensions as the first ceramic support layer 33.

The first ceramic support layer 33 is disposed on a first surface of the first carbon-fibre support layer 12, and the second ceramic support layer 43 is disposed on a second surface of the first carbon-fibre support layer 12 such that the first carbon-fibre support layer 12 is sandwiched between the first and second ceramic support layers.

As with the embodiment of FIGS. 4 and 5, the first electrically resistive heating filament 11 is provided on a surface of the first ceramic support layer 33. Unlike the embodiment of FIGS. 4 and 5, a second electrically resistive heating filament 41 is provided on a surface of the second ceramic support layer 43.

The first electrically resistive heating filament 11 is provided on a first surface of the first ceramic support layer 33 and the first carbon-fibre support layer 12 is provided on a second opposing surface of the first ceramic support layer 33.

The second electrically resistive heating filament 41 is provided on a first surface of the second ceramic support layer 43 and the first carbon-fibre support layer 12 is provided on a second opposing surface of the second ceramic support layer 43.

The heating element of all figures are substantially planar and elongate in shape in shape. The heating element has a total length of about 16 millimetres and a width of about 5 millimetres. The heating element includes a tapered point at one end. The longitudinal distance between the start of the taper and the end of the taper is about 4 millimetres.

The heating element of all embodiments further comprises a protective coating (not shown). The protective coating comprises a layer of quartz around the first electrically resistive heating filament 11, and where present the second electrically resistive heating filament 41, and the support substrate. The protective coating does not extend to the end of the heating element intended to be connected to the rest of the aerosol-generating device.

To form the heating element 10 of FIG. 1, carbon-fibre material is provided. A portion of platinum metal is applied to a surface of the carbon-fibre material using a deposition process to form a first electrically resistive heating filament 11. The portion of carbon-fibre material provided with the first electrically resistive heating filament 11 is cut from the bulk carbon-fibre material to form the heating element 10. The heating element 10 is then coated in a layer of quartz using dip coating to form a protective coating.

FIG. 8 shows a cross-sectional view of an aerosol-generating system comprising an aerosol generating article 100 and an aerosol-generating device 200. At one end of the aerosol generating article 100 an aerosol-forming substrate 102 is provided. At a second end of the aerosol generating article 100 a filter element 101 is provided.

The aerosol-generating device 200 comprises a housing 204 in which a power supply 205 and a controller circuitry 206 are arranged. At one end of the housing 204 a cavity 203 is formed that is configured to receive the aerosol generating article 100. In the cavity 203 a heating element 201 according to the present invention is provided. The heating element 201 is arranged centrally and along the longitudinal axis of the cavity 203.

The control circuitry 206 is configured for controlling the flow of electrical energy from the power source 205 to the heating element 201. In FIG. 8 the aerosol generating article 100 is inserted into the cavity 203 of the aerosol-generating device 200. After use the aerosol generating article 100 is removed from the cavity 203 and may be disposed.

1-15. (canceled)

16. A heating element for an aerosol-generating device, the heating element comprising:
a first electrically resistive heating filament; and
a support substrate on which the first electrically resistive heating filament is provided,
the support substrate comprising a first carbon-fibre support layer comprising a carbon-fibre material.

17. The heating element according to claim 16, further comprising a second electrically resistive heating filament.

18. The heating element according to claim 17, wherein the first carbon-fibre support layer comprises a first surface and an opposed second surface, the first electrically resistive heating filament being provided on the first surface of the first carbon-fibre support layer, and the second electrically resistive heating filament being provided on the second surface of the first carbon-fibre support layer.

19. The heating element according to claim 16, wherein the support substrate further comprises a first ceramic support layer comprising a ceramic material, the first ceramic support layer being in contact with the first carbon-fibre support layer.

20. The heating element according to claim 19, wherein the first electrically resistive heating filament is provided on the first ceramic support layer.

21. The heating element according to claim 19, wherein the support substrate further comprises a second ceramic support layer comprising a ceramic material, the second ceramic support layer being in contact with the first carbon-fibre support layer.

22. The heating element according to claim 19, wherein the first ceramic support layer further comprises silicon.

23. The heating element according to claim 19, wherein the first ceramic support layer has a thickness of between 0.1 millimetres and 0.7 millimetres.

24. The heating element according to claim 16, further comprising a protective coating around at least a portion of the first electrically resistive heating filament and the support substrate.

25. The heating element according to claim 16, wherein the first carbon-fibre support layer comprises a non-woven, unidirectional carbon-fibre material.

26. A method for forming a heating element for an aerosol-generating device, the method comprising steps of:
providing a carbon-fibre material;
applying a conductive material to a first surface of the carbon-fibre material to form a first electrically resistive heating filament; and
cutting a portion from the carbon-fibre material to form a heating element.

27. The method for forming a heating element according to claim 26, further comprising a step of applying a conductive material to a second surface of the carbon-fibre material to form a second electrically resistive heating filament.

28. The method for forming a heating element according to claim 26, further comprising a step of applying a layer of at least one of quartz and glass to the heating element to form a protective coating.

29. The method for forming a heating element according to claim 26, wherein the step of applying a conductive material to a first surface of the carbon-fibre material involves depositing a conductive material to a first surface of the carbon-fibre material.

30. An aerosol-generating device, comprising:
a heating element according to claim 16; and
a power source configured to provide electrical power to the first electrically resistive heating filament.
